(19) United States
(12) Patent Application Publication
(10) Pub. No.: US 2023/0306358 A1
(43) Pub. Date: Sep. 28, 2023

(54) PRINT MATERIAL SUPPLY DELIVERIES

(71) Applicant: Hewlett-Packard Development Company, L.P., Spring, TX (US)

(72) Inventors: Gabriel Scott McDaniel, Boise, ID (US); Jeffrey H Luke, Boise, ID (US); Sean Daniel FitzGerald, Boise, ID (US)

(21) Appl. No.: 18/023,372

(22) PCT Filed: Oct. 1, 2020
(86) PCT No.: PCT/US2020/053769

§ 371 Date: Feb. 26, 2023

(51) Int. Cl. G06Q 10/0832; G06Q 10/0833

(52) U.S. Cl. CPC G06Q 10/0832; G06Q 10/0833

(57) ABSTRACT

In some examples, a computing device can include a processing resource and a memory resource storing instructions to cause the processing resource to determine, for a print material supply to be shipped to a location, whether a thermal excursion is predicted to occur based on weather information for the location and shipping service information, determine, in response to the thermal excursion being predicted, whether an unsafe delivery of the print material supply is predicted to occur at the location, and in response to the unsafe delivery being predicted, cause thermal protection to be provided for the print material supply during shipment to the location.

### BACKGROUND

Imaging systems, such as printers, copiers, etc., may be used to form markings on a physical medium, such as text, images, etc. In some examples, imaging systems may form markings on the physical medium by performing a print job. A print job can include forming markings such as text and/or images by transferring a print material (e.g., ink, toner, etc.) to the physical medium.

### BRIEF DESCRIPTION OF THE DRAWINGS

FIG. 1 is an example of a system for print material supply deliveries consistent with the disclosure.

FIG. 2 is an example flow chart for print material supply deliveries consistent with the disclosure.

FIG. 3 is an example of a computing device for print material supply deliveries consistent with the disclosure,

FIG. 4 is a block diagram of an example system for print material supply deliveries consistent with the disclosure.

FIG. 5 is an example of a method for print material supply deliveries consistent with the disclosure.

### DETAILED DESCRIPTION

Imaging devices may include a supply of a print material. As used herein, the term “print material” refers to a substance which can be transported through and/or utilized by an imaging device. In some examples, print material can be, for instance, a material that when applied to a medium, can form representation(s) (e.g., text, images, models, etc.) on the medium during a print job. Print material may include ink, toner, polymers, metals, colorants, etc.

The print material can be deposited onto a physical medium. As used herein, the term “imaging device” refers to any hardware device with functionalities to physically produce representation(s) (e.g., text, images, models, etc.) on the medium. In some examples, a “medium” may include paper, photopolymers, plastics, composite, metal, wood, fabric, or the like. An imaging device can be a printing device (e.g., a printer). An imaging device can include printing (e.g., two-dimensional printing and/or three-dimensional printing capabilities), scanning, faxing, and/or other imaging device functionalities, and can perform print jobs when in receipt of a print job request from a computing device or other network (e.g., Internet) connected device.

A device, such as a computing device, can generate a print job request and transmit the print job request to an imaging device. The imaging device can perform the print job according to the received print job request.

An imaging device can perform the print job by depositing print material onto a print medium from a print material supply or other print medium reloading device. As used herein, the term “print material supply” refers to a vessel including print material. For example, the print material supply can include print material that can be deposited onto a print medium to form text and/or images on the print medium during a print job.

When an amount of print material remaining in a print material supply is low, a user may order another print material supply and/or the supplier may supply another print material supply prior to the print material supply running out of print material. Such print material supplies may be shipped to the user from the supplier.

Print material supplies may be shipped from a supplier to a broad range of locations. Different locations may include different environmental conditions such as temperatures, humidity levels, dust-heavy or micro-particle rich air, etc. For example, one print material supply may be shipped to or through a location or geography having very cold temperatures, another print material supply may be shipped to or through a location or geography having mild temperatures, and another print material supply may be shipped to or through a location or geography having very high temperatures.

Exposure to certain temperatures may be harmful to, or the contents within, a print material supply. For example, exposure of a print material supply to high or low temperatures can damage and/or destroy a print material supply's contents or the cartridge itself, as print material in the print material supply may clump or form a solid mass. This can result in a negative user experience as well as be a financial loss for a supplier or customer.

Print material supply deliveries according to the disclosure can allow for determination of whether a delivery of a print material supply to or through a location may be unsafe for the print material supply. For example, weather information may allow a computing device to predict the print material supply may be subject to a thermal excursion. As used herein, the term “thermal excursion” refers to an event in which an item is exposed to a temperature outside of a prescribed temperature range. Based on such a prediction, thermal protections can be provided to the print material supply. Deliveries of print material supplies in such a manner can prevent a delivered print material supply from being damaged, avoiding a negative user experience for a user.

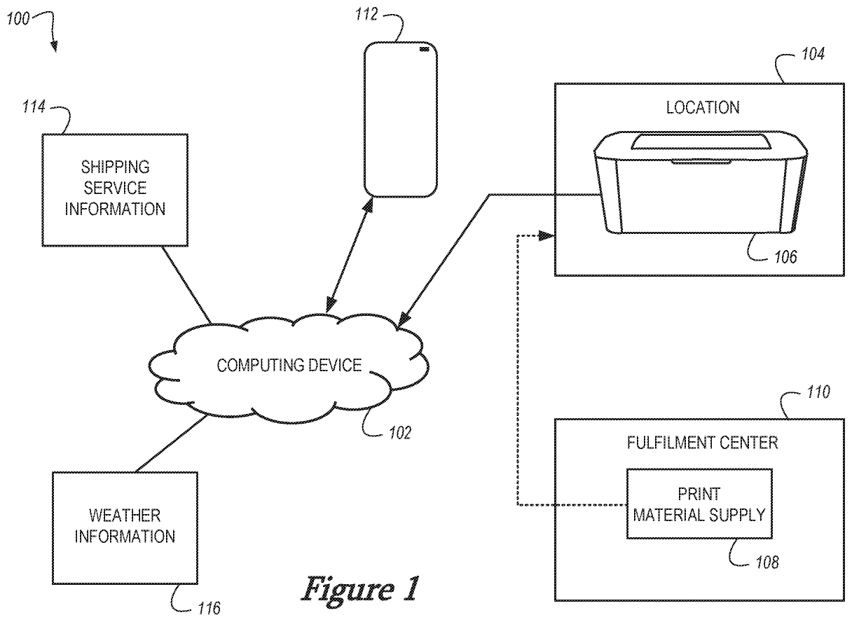

FIG. 1 is an example of a system for print material supply deliveries consistent with the disclosure. The system 100 can include a computing device 102, a location 104, an imaging device 106, a print material supply 108, a fulfillment center 110, a mobile device 112, shipping service information 114, and weather information 116.

As is further described herein, the computing device 102 can utilize shipping service information 114 and weather information 116 to facilitate a safe delivery of the print material supply 108 to the location 104. In order to begin the delivery of the print material supply 108, the computing device 102 can receive a fulfillment signal from the imaging device 106 via a wired or wireless connection, as is further described herein. As used herein, the term “fulfillment signal” refers to a transmission that includes information detailing a state of a print material supply included in an imaging device. For example, the fulfillment signal can indicate to the computing device 102 that based on previous print jobs and an amount of print material remaining in the print material supply included in the imaging device 106 (e.g., not illustrated in FIG. 1), the computing device 102 can cause a shipment of the print material supply 108 to the location 104. The print material supply 108 can be shipped to the location 104 in order to be installed in the imaging device 106 to allow the imaging device 106 to continue to perform print jobs.

When the computing device 102 receives a fulfillment signal, the computing device 102 can schedule a shipment of the print material supply 108 to the location 104 via a shipping service. As used herein, the term “shipment” refers to transportation of an item from one location to another location. As used herein, the term “shipping service” refers to a supplier of transportation of an item. For example, the computing device 102 can select a shipping service to schedule transportation of the print material supply 108 from the fulfillment center 110 to the location 104.

As used herein, the term “computing device” refers to an electronic system having a processing resource, memory resource, and/or an application-specific integrated circuit (ASIC) that can process information. Examples of computing devices can include, for instance, a laptop computer, a notebook computer, a desktop computer, a server, networking equipment (e.g., router, switch, etc.), and/or a mobile device, among other types of computing devices.

The print material supply 108 can be shipped to the location 104 based on location information for the location 104. Location information can include, for example, an address for the location 104. However, examples of the disclosure are not so limited. In some examples, the location information can be determined based on an Internet Protocol (IP) address of the imaging device 106. In some examples, the location information associated with the location 104 can include geolocation mechanisms (e.g., global positioning system (GPS), Wi-Fi, Internet Protocol (IP) address, Point of Presence, etc.) to determine a location of the imaging device 106 which can correspond to the location information for the location 104.

The computing device 102 can determine whether a thermal excursion is predicted to occur for the print material supply 108. For example, a thermal excursion can include the print material supply 108 being exposed to a temperature outside of a given temperature range for a particular amount of time. Such a thermal excursion may occur when delivery of the print material supply 108 occurs at the location 104, as is further described herein.

The thermal excursion can be determined based on a predicted time period for a delivery of the print material supply 108 to the location 104. Such a predicted time period for the delivery of the print material supply 108 to the location 104 can be determined according to shipping service information 114 associated with the shipping service. Shipping service information 114 may include information regarding shipping services, transit times for deliveries, delivery equipment offered by the shipping services, past delivery information, etc. For example, the computing device 102 can access shipping service information 114 of a plurality of shipping services in order to determine location information of the location 104 (e.g., address information), location information of the fulfillment center 110, and determine a shipping route and/or transit time for the print material supply 108 from the fulfillment center 110 to the location 104. For example, the fulfillment center 110 may be located in Colorado and the location 104 may be located in Arizona. The computing device 102 can determine the predicted time period (e.g., September 10^{th}) for the delivery of the print material supply 108 to the location 104 in Arizona utilizing a particular shipping service using the shipping service information 114.

The thermal excursion can additionally be determined based on weather information for the location 104. As used herein, the term “weather information” refers to data describing environmental conditions in a location. Weather information can include, for example, temperature, pressure, humidity, wind conditions, dust conditions, pollen counts, ultraviolet (UV) index, dew points, barometric pressure, cloud cover, among other types of weather information. The computing device 102 can determine weather information for the location 104 utilizing weather information 116. Weather information 116 can include information gathered and provided by a weather data service to the computing device 102 for different locations where a print material supply may be shipped. The weather information 116 can include forecasted weather information, historical weather information, current weather conditions, etc. As used herein, the term “forecasted weather information” refers to weather information for a time in the future. For example, the computing device 102 can determine the forecasted temperature for the location 104 (e.g., 95° Fahrenheit (F)) for the predicted time period (e.g., September 10^{th}) for the delivery, historical temperature information (e.g., 90° F. on September 10^{th} the previous year(s)), current conditions (e.g., 87° F. on September 3^{rd}, one week before the predicted time period for delivery), etc. Additionally, as used herein, the term “historical weather information” refers to weather information for a time in the past. Further, as used herein, the term “current weather information” refers to weather information for the present time.

Based on the predicted time period for the delivery (e.g., September 10^{th}) and the weather information for the location (e.g., forecasted to be 95° F.) for the predicted time period (e.g., September 10^{th}), the computing device can determine predict a thermal excursion to occur for the print material supply 108. For example, the forecasted temperature (e.g., 95° F.) for the predicted time period can be outside of a given temperature range (e.g., 40° F. to 80° F.) and accordingly, the computing device 102 can determine that a thermal excursion is predicted to occur for the print material supply 108.

In response to the thermal excursion being predicted, the computing device 102 can determine whether an unsafe delivery of the print material supply is predicted to occur at the location 104. As used herein, the term “unsafe delivery” refers to surrendering a print material supply in an environment having conditions that can damage the print material supply. Such a determination of an unsafe delivery can be, in some examples, based on delivery site setup information about the location 104, as is further described herein.

The computing device 102 can receive delivery site setup information from a mobile device 112. As used herein, the term “delivery site setup information” refers to data describing a capability for a user and/or a location to receive a delivery. For example, delivery site setup information can include delivery options such as a delivery location at the location 104 (e.g., a mailbox, a garage, an outside delivery location such as a doorstep, a drop off location such as a front desk (e.g., to be received by an employee), a delivery locker location, etc.), security at the location (e.g., whether a mailbox, garage, etc, includes a lock, the type of lock (e.g., keyed, keypad, etc.), access mechanisms for the locks (e.g., a key, entry code, etc.), an employee to receive a delivery, etc.). Additionally, delivery site setup information can include a user schedule (e.g., times and/or dates the user can be available to receive a delivery), user delivery preferences (e.g., whether the user would like have a signature for the delivery, whether the user would like a signature-less delivery, etc.). For example, a user who is to receive the print material supply 108 can specify that they are typically at the location 104 and available to receive the print material supply 108 Mondays-Fridays from 4 PM to 10 PM and Saturdays-Sundays from 8 AM to 10 PM, that they would like to not provide a signature prior to completing deliveries, and that the shipping service leave the print material supply 108 in a mailbox located at the location 104.

A user can setup delivery site setup information utilizing the mobile device 112. As used herein, the term “mobile device” can include devices that are (or can be) carried and/or worn by the user. For example, mobile device 112 can be a phone (e.g., a smart phone), a tablet, a personal digital assistant (PDA), smart glasses, and/or a wrist-worn device (e.g., a smart watch), among other types of mobile devices.

For example, a user can enroll in a print material supply shipping service that automatically supplies a print material supply 108 when a print material supply in their imaging device 106 may be low on print material. When enrolling in such a service, the user can setup delivery site setup information by providing inputs to the mobile device 112. The mobile device 112 can transmit such information to the computing device 102 to facilitate shipments of print material supplies to the user, as is further described herein.

The mobile device 112 can transmit the delivery site setup information about the location 104 to the computing device 102 via a wired or wireless connection. The wired or wireless network connection can be a network relationship that connects the mobile device 112 to the computing device 102. Examples of such a network relationship can include a local area network (LAN), wide area network (WAN), personal area network (PAN), a distributed computing environment (e.g., a cloud computing environment), storage area network (SAN), Metropolitan area network (MAN), a cellular communications network, Long Term Evolution (LTE), visible light communication (VLC), Bluetooth, Worldwide Interoperability for Microwave Access (WiMAX), infrared (IR) communication, Public Switched Telephone Network (PSTN), radio waves, and/or the Internet, among other types of network relationships.

The computing device 102 can determine whether an unsafe delivery of the print material supply is predicted to occur at the location 104 based on the delivery site setup information about the location. Continuing with the example above, according to the delivery site setup information about the location 104 (e.g., user would like to not provide a signature prior to a delivery being made, the shipping service leave a delivery in a mailbox located at the location 104, and that the mailbox is not secured (e.g., by a locking mechanism)), the print material supply 108 is to be delivered without a signature to a mailbox located at the location 104 on a Friday (e.g., September 10^{th}) at 1 PM. In conjunction with the weather information (e.g., a forecasted temperature of 95° F., no forecasted cloud cover, low wind conditions, etc), the computing device 102 can determine that since a user has indicated they are not home until 4 PM on Fridays, and that because the forecasted temperature (95° F.) exceeds the given temperature range (e.g., 40° F. to 80° F.), the print material supply 108 would be exposed to direct sunlight as well as a temperature outside the given temperature range for 3 hours, and that as a result, the an unsafe delivery is predicted to occur.

In some examples, computing device 102 can further determine whether the unsafe delivery is predicted to occur based on a user input received from the mobile device 112. For example, the computing device 102 can transmit a notification to the mobile device 112 that an unsafe delivery is predicted. The notification can, for instance, ask a user of the mobile device 112 whether they would like to proceed with the delivery or reschedule the delivery. In some examples, the user can indicate they would like to reschedule the delivery, and in such an example, the user can indicate a delivery date, the computing device 102 can provide options for future delivery dates which can be selected by a user, etc. In some examples, the user can indicate they would like to proceed with the delivery, and in such an example, the computing device 102 can further determine that an unsafe delivery is predicted to occur.

In some examples, the computing device 102 can determine whether the unsafe delivery is predicted to occur based on a location of the mobile device 112. The computing device 102 can determine whether such unsafe delivery is predicted based on the location of the mobile device 112 in conjunction with delivery site setup information. For instance, the unsafe delivery prediction can be utilized in order to supplement and/or validate the delivery site setup information.

The location can include past location data (e.g., past locations of where the mobile device 112 is located, networks it was connected to, etc.) and/or current location data. The location of the mobile device 112 can be determined based on a GPS location of the mobile device 112, whether the mobile device 112 is connected to a A/i-Fi network at the location 104, a cell site (e.g., cell tower) the mobile device 112 is connected to, etc. Such location data can be transmitted to the computing device 102. For example, the mobile device 112 can determine it is within a threshold distance of the location 104 at a particular time using GPS data. As another example, the mobile device 112 can determine it is within a threshold distance of the location 104 at a particular time as it is connected to a Wi-Fi network at the location 104. As a further example, the mobile device 112 can determine it is within a threshold distance of the location 104 at a particular time based on the cell site the mobile device 112 is connected to.

In some examples, based on the location of the mobile device determined via GPS, the computing device 102 can determine whether an unsafe delivery is predicted to occur at the location. For example, the print material supply 108 may be scheduled to be delivered at 1 PM on Friday, September 10^{th}. The computing device 102 can utilize past GPS location data to determine that a user is not typically at home (e.g., mobile device 112 is not within a threshold distance from the location 104 at 1 PM on Fridays) and/or current GPS location data (e.g., mobile device 112 is not currently within a threshold distance from the location 104 and it is 1 PM on a Friday) and that an unsafe delivery is scheduled to occur. In some such examples, the computing device 102 can transmit a notification to the mobile device 112 that an unsafe delivery is predicted, where the notification can ask a user of the mobile device 112 whether they would like to proceed with the delivery or reschedule the delivery.

In some examples, based on the location of the mobile device determined via connection to a Wi-Fi network at the location 104, the computing device 102 can determine whether an unsafe delivery is predicted to occur at the location. For example, the print material supply 108 may be scheduled to be delivered at 1 PM on Friday, September 10^{th}. The computing device 102 can utilize past W-Fi connection data to determine that a user is not typically at home (e.g., mobile device 112 is not usually connected to the Wi-Fi connection at the location 104 at 1 PM on Fridays) and/or current W-Fi connection data (e.g., mobile device 112 is not currently connected to the W-Fi connection at the location 104 and it is 1 PM on a Friday) and that an unsafe delivery is scheduled to occur. In some such examples, the computing device 102 can transmit a notification to the mobile device 112 that an unsafe delivery is predicted, where the notification can ask a user of the mobile device 112 whether they would like to proceed with the delivery or reschedule the delivery.

In some examples, based on the location of the mobile device determined via connection to a cell site corresponding to the location 104, the computing device 102 can determine whether an unsafe delivery is predicted to occur at the location. For example, the print material supply 108 may be scheduled to be delivered at 1 PM on Friday, September 10^{th}. The computing device 102 can utilize past connection data to the cell site to determine that a user is not typically at home (e.g., mobile device 112 is not usually connected to the cell site corresponding to the location 104 at 1 PM on Fridays) and/or current connection data to the cell site (e.g., mobile device 112 is not currently connected to the cell site associated with the location 104 and it is 1 PM on a Friday) and that an unsafe delivery is scheduled to occur. In some such examples, the computing device 102 can transmit a notification to the mobile device 112 that an unsafe delivery is predicted, where the notification can ask a user of the mobile device 112 whether they would like to proceed with the delivery or reschedule the delivery.

Although the location of the mobile device 112 is described above as being determined based on GPS, W-Fi connection data, and/or cell site connection data corresponding to the location 104, examples of the disclosure are not so limited. For example, the location of the mobile device 112 can be determined based on any other location determination mechanism.

In some examples, the computing device 102 can determine whether the unsafe delivery is predicted to occur based on an input from an Internet of Things (IoT) device at the location 104. As used herein, the term “IoT device” refers to a device including sensors, software, and/or other technology in order to connect and exchange data with other devices. For example, an IoT device may include thermostats, doorbells, appliances, lighting fixtures, security systems, cameras, speakers, etc.

In some examples, certain data from IoT devices may be transmitted to the computing device 102, Such data may be utilized to determine whether an unsafe delivery is predicted to occur, as is further described herein.

For example, an IoT device at the location 104 may include a thermostat. The thermostat may transmit data to the computing device 102. For example, the thermostat may be set so that no cooling is set to occur in the space of the location 104 between 8 AM and 4 PM on Mondays-Fridays (e.g., which corresponds to times when a user is not at the location 104). The print material supply 108 may be scheduled to be delivered at 1 PM on Friday, September 10^{th}. Setpoint data for the thermostat may indicate that a user is not typically at the location 104 on Fridays at 1 PM, and therefore the computing device 102 can determine that an unsafe delivery is predicted to occur. In some such examples, the computing device 102 can transmit a notification to the mobile device 112 that an unsafe delivery is predicted, where the notification can ask a user of the mobile device 112 whether they would like to proceed with the delivery or reschedule the delivery.

As another example, the thermostat may receive an input (e.g., to start cooling the location 104 where the input is received within a threshold time window of 1 PM), and such information can be transmitted to the computing device 102. Accordingly, the computing device 102 can determine that based on the input to the thermostat, the user may be at the location 104 and as such, determine that the delivery is not predicted to be unsafe.

As another example, an IoT device at the location 104 may include a speaker which can transmit data to the computing device 102. For example, the user may typically play music, listen to news, etc. via the speaker at times between 4 PM and 10 PM Mondays-Fridays (e.g., which corresponds to times when a user is at the location 104). The print material supply 108 may be scheduled to be delivered at 1 PM on Friday, September 10^{th}, Data from the speaker may indicate that the speaker does not typically output audio on Fridays at 1 PM, and therefore the computing device 102 can determine that an unsafe delivery is predicted to occur. In some such examples, the computing device 102 can transmit a notification to the mobile device 112 that an unsafe delivery is predicted, where the notification can ask a user of the mobile device 112 whether they would like to proceed with the delivery or reschedule the delivery.

As another example, the speaker may receive an input (e.g., to start outputting audio within a threshold time window of 1 PM), and such information can be transmitted to the computing device 102. Accordingly, the computing device 102 can determine that based on the input to the speaker, the user may be at the location 104 and as such, determine that the delivery is not predicted to be unsafe.

Although IoT devices are described above as including thermostats, doorbells, appliances, lighting fixtures, security systems, cameras, speakers, etc., examples of the disclosure are not so limited. For example, any other type of device that includes sensors, software, and/or other technology that can connect and exchange data with other devices may be utilized to determine whether a user is at the location 104 or not and accordingly, whether an unsafe delivery is predicted to occur.

In response to the unsafe delivery being predicted, the computing device 102 can cause thermal protection to be provided for the print material supply 108 during shipment to the location 104. As used herein, the term “thermal protection” refers to a guarding action against damage to an item by temperature. For example, the computing device 102 can take an action to guard against damage to the print material supply 108 by temperature, as is further described herein.

In some examples, causing the thermal protection to be provided can include rescheduling the predicted time period for the delivery. For example, the computing device 102 can transmit a notification to the mobile device 112 of a user (e.g., a recipient) of the print material supply 108 that delivery of the print material supply 108 is scheduled to occur within a threshold amount of time relative to the predicted time period for the delivery. For instance, the recipient can receive the notification at 10 AM on September 10^{th} that delivery of the print material supply 108 is scheduled for 1 PM on September 10^{th}, In response to receiving a confirmation of the delivery from the mobile device 112, the computing device 102 can cause the delivery to occur. In some examples, in response to not receiving a confirmation of the delivery (e.g., or receiving a rescheduling notification), the computing device 102 can cause the delivery to be rescheduled. In some examples, the computing device 102 can transmit the notification in response to a temperature at the location 104 exceeding a threshold temperature. The computing device can cause the predicted time period for delivery to be rescheduled from September 10^{th} (e.g., when the forecast high temperature is 95° F.) to September 11^{th} (e.g., when the forecast high temperature is 80° F.). Rescheduling of the predicted time period for the delivery can be done by the computing device 102. In some examples, the computing device 102 can transmit a rescheduled time period for delivery to the mobile device 112 for a user to confirm, and in response to receiving a confirmation from the mobile device 112, cause the rescheduled time period for delivery to occur.

In some examples, causing thermal protection to be provided can include holding the print material supply 108 at the fulfillment center 110, a distribution center, or other area. For example, the location 104 may be located proximate to a distribution center where the print material supply 108 may be located during transit from the fulfillment center 110. The computing device 102 can transmit a notification to the mobile device 112 for a user to confirm whether they would like the shipping service to continue to hold the print material supply 108 at the distribution center for pickup by the user, reschedule the predicted time period for the delivery, etc. In response to receiving a confirmation by the computing device 102 from the mobile device 112, the computing device 102 can cause the print material supply 108 to be held at the distribution center, can reschedule a predicted time period for delivery, etc.

In some examples, causing thermal protection to be provided can include causing a message to be sent to a delivery driver (e.g., of the shipping service) to alert the delivery driver to deliver the print material supply 108 in a manner as to prevent the print material supply 108 from being exposed to a temperature outside the temperature range for a given amount of time. For example, the message can alert the delivery driver to deliver the print material supply 108 inside a garage at the location 104, even though that may not be included in delivery site setup information. In some examples, a user may be notified of such an action via the mobile device 112 by the computing device 102 and can approve/disapprove accordingly.

In some examples, causing thermal protection to be provided can include selecting an alternate shipping service. For example, the alternate shipping service may be selected as the delivery vehicles in the delivery fleet of the alternate shipping service may include air conditioning so as to not expose the print material supply 108 to temperatures outside a given temperature range. As another example, while the predicted time period for delivery of the print material supply 108 for a first shipping service may be September 10^{th} (with a forecasted high temperature of 95° F.), a second shipping service may include a predicted time period for delivery of the print material supply 108 for September 9^{th} (with a forecasted high temperature of 80° F.), and accordingly, the second shipping service may be selected so as to deliver the print material supply 108 earlier and on a predicted time period with a lower forecasted temperature.

In some examples, causing thermal protection to be provided can include causing the shipping service to package the print material supply 108 to remediate the unsafe delivery. For example, the computing device 102 can cause the shipping service to package the print material supply 108 in packaging that thermally protects the print material supply 108 from excess heat. The computing device 102 can additionally verify that the shipping service is able to ship the print material supply 108 to the location 104 at the predicted time period for delivery with the thermally protected packaging and/or within the temperature limits. In an instance in which causing the shipping service to package the print material supply 108 in packaging would cause the shipping service to not be able to ship the print material supply 108 to the location 108 at the predicted time period for delivery and/or the thermal protections would not be able to protect the print material supply 108 upon delivery (e.g., due to weather conditions), the computing device 102 can reschedule the predicted time period for delivery, allow the user to select a different shipping service, etc.

The computing device 102 can cause the print material supply 108 to be shipped to the location 104. For example, the computing device 102 can cause the shipping service to transport the print material supply 108 from the fulfillment center 110 to the location 104 utilizing the thermal protections described above in order for a user to receive the print material supply 108 in working order.

Following delivery of the print material supply 108, the computing device 102 can determine whether a temperature at the location 104 exceeds a threshold temperature within a range of time after the delivery of the print material supply 108. For example, the print material supply 108 may be delivered to the location 104 on September 11^{th} at 12 PM, where on September 11^{th} a forecasted high temperature is to be 75° F. If the temperature at the location 104 on September 11^{th} rises to 83° F. (e.g., exceeding the forecasted high temperature) within a predetermined range of time (e.g., 4 hours) after 12 PM, the computing device 102 can transmit a notification to the mobile device 112 of the recipient of the print material supply 108. Such a notification may alert the recipient of the print material supply 108 that the temperature at the location 104 has exceeded a forecasted high temperature and as a result, damage may occur to the print material supply 108 if no remedial action is taken. Accordingly, the recipient may act to move the print material supply 108 to a location in order to prevent damage to the print material supply 108 following delivery.

Print material supply deliveries according to the disclosure can allow for delivery of a print material supply while avoiding damage to the print material supply if exposed to extreme temperatures. Avoiding damage or destruction of the print material supply can prevent a supplier from having to replace damaged or destroyed print material supplies for a user and can increase user satisfaction as compared with previous approaches.

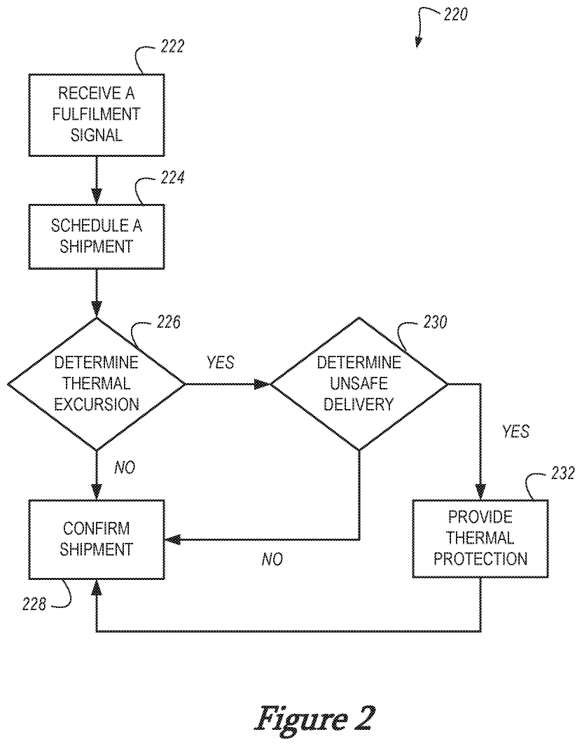

FIG. 2 is an example flow chart 220 for print material supply deliveries consistent with the disclosure. At 222, a computing device (e.g., computing device 102) may receive a fulfillment signal from an imaging device (e.g., imaging device 106). For example, the imaging device may transmit the fulfillment signal to the computing device so that a replacement print material supply is shipped to a location of the imaging device. Accordingly, at 224, the computing device can schedule a shipment.

At 226, the computing device can determine whether a thermal excursion is predicted to occur for the print material supply. The thermal excursion can be predicted based on a predicted time period for a delivery of the print material supply to the location and weather information for the location. The predicted time period for the delivery of the print material supply can be determined according to shipping information associated with a shipping service.

If no thermal excursion is predicted, the computing device can confirm shipment of the print material supply at 228. However, if a thermal excursion is predicted, the computing device can, at 230, determine whether an unsafe delivery of the print material supply is expected to occur at the location. The unsafe delivery of the print material supply can be predicted based on delivery site setup information about the location, a user input to a mobile device, a location of the mobile device, and/or an input from an IoT device. Such delivery site setup information can be provided to the computing device by a user.

If an unsafe delivery of the print material supply is not determined, the computing device can confirm shipment of the print material supply at 228. If an unsafe delivery of the print material supply is determined, the computing device can cause the print material supply to be provided thermal protection. Such thermal protection can allow the print material supply to be delivered to the location without damage and/or destruction to the print material supply (e.g., as a result of exposure to extreme high or low temperatures). After being provided thermal protection, the computing device can confirm shipment of the print material supply at 228.

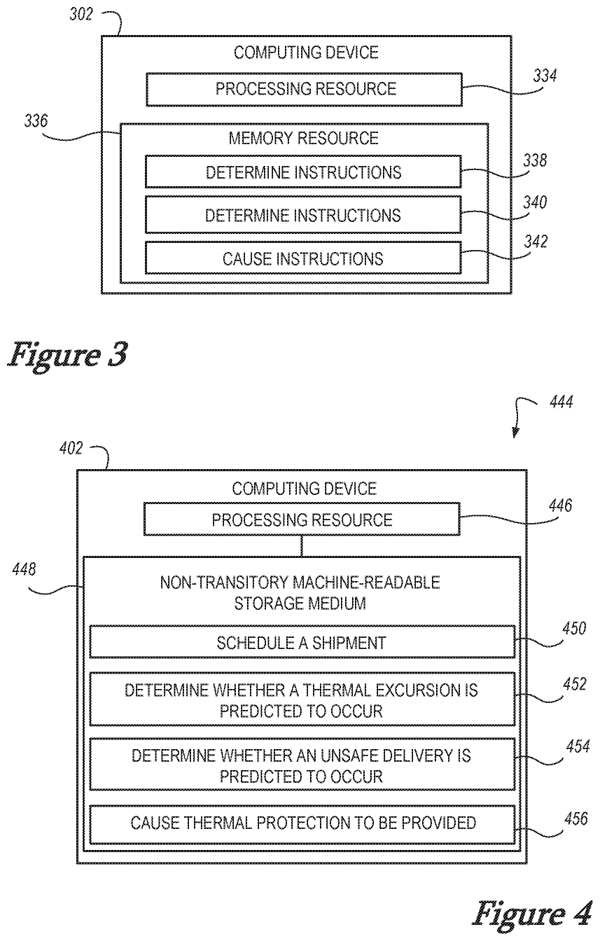

FIG. 3 is an example of a computing device 302 for print material supply deliveries consistent with the disclosure. As described herein, the computing device 302 may perform functions related to print material supply deliveries. Although not illustrated in FIG. 3, the computing device 302 may include a processor and a machine-readable storage medium. Although the following descriptions refer to a single processor and a single machine-readable storage medium, the descriptions may also apply to a system with multiple processors and multiple machine-readable storage mediums. In such examples, the computing device 302 may be distributed across multiple machine-readable storage mediums and across multiple processors. Put another way, the instructions executed by the computing device 302 may be stored across multiple machine-readable storage mediums and executed across multiple processors, such as in a distributed or virtual computing environment.

Processing resource 334 may be a central processing unit (CPU), a semiconductor-based microprocessor, and/or other hardware devices suitable for retrieval and execution of machine-readable instructions 338, 340, 342 stored in a memory resource 336. Processing resource 334 may fetch, decode, and execute instructions 338, 340, 342. As an alternative or in addition to retrieving and executing instructions 338, 340, 342, processing resource 334 may include a plurality of electronic circuits that include electronic components for performing the functionality of instructions 338, 340, 342.

Memory resource 336 may be any electronic, magnetic, optical, or other physical storage device that stores executable instructions 338, 340, 342, and/or data. Thus, memory resource 336 may be, for example, Random Access Memory (RAM), an Electrically-Erasable Programmable Read-Only Memory (EEPROM), a storage drive, an optical disc, and the like. Memory resource 336 may be disposed within computing device 302, as shown in FIG. 3. Additionally, memory resource 336 may be a portable, external or remote storage medium, for example, that causes computing device 302 to download the instructions 338, 340, 342 from the portable/external/remote storage medium.

The computing device 302 may include instructions 338 stored in the memory resource 336 and executable by the processing resource 334 to determine, for a print material supply to be shipped to a location, whether a thermal excursion is predicted to occur. The thermal excursion can be predicted to occur based on weather information for the location and shipping service information.

The computing device 302 may include instructions 340 stored in the memory resource 336 and executable by the processing resource 334 to determine, in response to the thermal excursion being predicted, whether an unsafe delivery of the print material supply is predicted to occur at the location. The computing device 302 can determine whether the unsafe delivery of the print material supply is predicted to occur based on delivery site setup information about the location received from a mobile device, a user input to a mobile device, a location of the mobile device, and/or an input from an IoT device.

The computing device 302 may include instructions 342 stored in the memory resource 336 and executable by the processing resource 334 to cause, in response to the unsafe delivery being predicted, thermal protection to be provided for the print material supply during shipment to the location.

FIG. 4 is a block diagram of an example system 444 for print material supply deliveries consistent with the disclosure. In the example of FIG. 4, system 444 includes a computing device 402 including a processing resource 446 and a non-transitory machine-readable storage medium 448. Although the following descriptions refer to a single processing resource and a single machine-readable storage medium, the descriptions may also apply to a system with multiple processors and multiple machine-readable storage mediums. In such examples, the instructions may be distributed across multiple machine-readable storage mediums and the instructions may be distributed across multiple processors. Put another way, the instructions may be stored across multiple machine-readable storage mediums and executed across multiple processors, such as in a distributed computing environment.

Processing resource 446 may be a central processing unit (CPU), microprocessor, and/or other hardware device suitable for retrieval and execution of instructions stored in machine-readable storage medium 448. In the particular example shown in FIG. 4, processing resource 446 may receive, determine, and send instructions 450, 452, 454, 456. As an alternative or in addition to retrieving and executing instructions, processing resource 446 may include an electronic circuit comprising a number of electronic components for performing the operations of the instructions in machine-readable storage medium 448. With respect to the executable instruction representations or boxes described and shown herein, it should be understood that part or all of the executable instructions and/or electronic circuits included within one box may be included in a different box shown in the figures or in a different box not shown.

Machine-readable storage medium 448 may be any electronic, magnetic, optical, or other physical storage device that stores executable instructions. Thus, machine-readable storage medium 448 may be, for example, Random Access Memory (RAM), an Electrically-Erasable Programmable Read-Only Memory (EEPROM), a storage drive, an optical disc, and the like. The executable instructions may be “installed” on the system 444 illustrated in FIG. 4. Machine-readable storage medium 448 may be a portable, external or remote storage medium, for example, that allows the system 444 to download the instructions from the portable/external/remote storage medium. In this situation, the executable instructions may be part of an “installation package”.

Schedule a shipment instructions 450, when executed by a processor such as processing resource 446, may cause system 444 to schedule a shipment of a print material supply to a location via a shipping service. Such a shipment may be scheduled in response to a fulfillment signal being received by the computing device 402.

Determine whether a thermal excursion is predicted to occur instructions 452, when executed by a processor such as processing resource 446, may cause system 444 to determine whether a thermal excursion is predicted to occur for the print material supply. The thermal excursion can be predicted to occur based on weather information for the location and a predicted time period for a delivery of the print material supply to the location according to shipping service information associated with the shipping service.

Determine whether an unsafe delivery is predicted to occur instructions 454, when executed by a processor such as processing resource 446, may cause system 444 to determine, in response to the thermal excursion being predicted, whether an unsafe delivery of the print material supply is predicted to occur at the location based on delivery site setup information about the location. The computing device 402 can determine whether the unsafe delivery of the print material supply is predicted to occur based on delivery site setup information about the location received from a mobile device a user input to a mobile device, a location of the mobile device, and/or an input from an IoT device.

Cause thermal protection to be provided instructions 456, when executed by a processor such as processing resource 446, may cause system 444 to cause thermal protection to be provided for the print material supply during shipment to the location in response to the unsafe delivery being predicted.

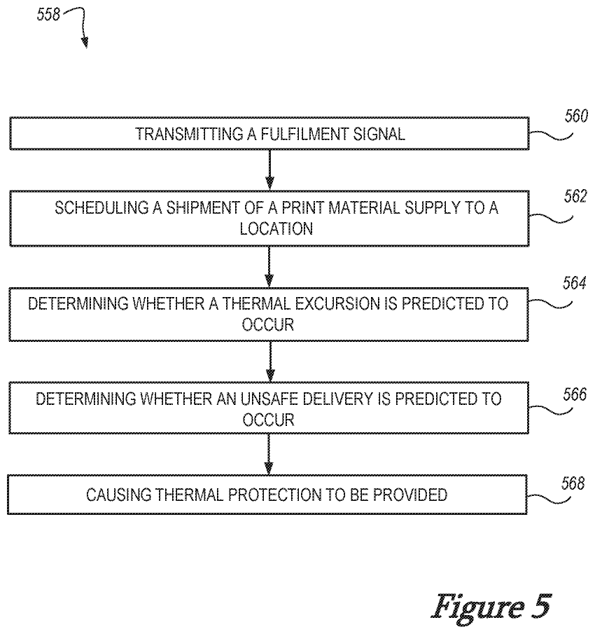

FIG. 5 is an example of a method 558 for print material supply deliveries consistent with the disclosure. The method 558 can be performed by a computing device (e.g., computing device 102, 302, and 402, previously described in connection with FIGS. 1, 3, and 4, respectively).

At 560, the method 558 includes transmitting, by an imaging device including a first print material supply, a fulfillment signal to a computing device in response to an amount of print material in the first print material supply being less than a threshold amount. For example, the amount of print material in the first print material supply may be running low and if not replaced, may begin to execute print jobs that form representations (e.g., text, images, models, etc.) on a print medium that may be faded relative to a new print material supply.

At 562, the method 558 includes scheduling, by the computing device, a shipment of a second print material supply to the location via a shipping service in response to receiving the fulfillment signal from the imaging device.

At 564, the method 558 includes determining, by the computing device, whether a thermal excursion is predicted to occur for the second print material supply. The thermal excursion can be predicted to occur based on a predicted time period for a delivery of the second print material supply to the location according to shipping information associated with the shipping service and weather information for the location.

At 566, the method 558 includes determining, by the computing device in response to the thermal excursion being predicted, whether an unsafe delivery of the second print material supply is predicted to occur at the location based on the delivery site setup information.

At 568, the method 558 includes causing, by the computing device in response to the unsafe delivery being predicted, thermal protection to be provided for the second print material supply during shipment to the location.

In the foregoing detailed description of the disclosure, reference is made to the accompanying drawings that form a part hereof, and in which is shown by way of illustration how examples of the disclosure may be practiced. These examples are described in sufficient detail to enable those of ordinary skill in the art to practice the examples of this disclosure, and it is to be understood that other examples may be utilized and that process, electrical, and/or structural changes may be made without departing from the scope of the disclosure. Further, as used herein, “a” can refer to one such thing or more than one such thing.

The figures herein follow a numbering convention in which the first digit corresponds to the drawing figure number and the remaining digits identify an element or component in the drawing. For example, reference numeral 100 may refer to element 102 in FIG. 1 and an analogous element may be identified by reference numeral 302 in FIG. 3. Elements shown in the various figures herein can be added, exchanged, and/or eliminated to provide additional examples of the disclosure. In addition, the proportion and the relative scale of the elements provided in the figures are intended to illustrate the examples of the disclosure, and should not be taken in a limiting sense.

It can be understood that when an element is referred to as being “on,” “connected to”, “coupled to”, or “coupled with” another element, it can be directly on, connected, or coupled with the other element or intervening elements may be present. In contrast, when an object is “directly coupled to” or “directly coupled with” another element it is understood that are no intervening elements (adhesives, screws, other elements) etc.

The above specification, examples and data provide a description of the method and applications, and use of the system and method of the disclosure. Since many examples can be made without departing from the spirit and scope of the system and method of the disclosure, this specification merely sets forth some of the many possible example configurations and implementations.

What is claimed is:

1. A computing device, comprising:
a processing resource; and
a memory resource storing non-transitory machine-readable instructions to cause the processing resource to:
determine, for a print material supply to be shipped to a location, whether a thermal excursion is predicted to occur based on weather information for the location and shipping service information;
determine, in response to the thermal excursion being predicted, whether an unsafe delivery of the print material supply is predicted to occur at the location; and
in response to the unsafe delivery being predicted, cause thermal protection to be provided for the print material supply during shipment to the location.

2. The computing device of claim 1, wherein:
the processing resource is to determine whether the thermal excursion is predicted to occur based on a predicted time period for a delivery of the print material supply to the location based on the shipping service information; and
the weather information includes forecasted weather information for the predicted time period for the delivery of the print material supply to the location.

3. The computing device of claim 1, wherein the processing resource is to determine whether the unsafe delivery is predicted to occur based on delivery site setup information about the location received from a mobile device.

4. The computing device of claim 1, wherein the processing resource is to determine whether the unsafe delivery is predicted to occur based on a user input received from a mobile device.

5. The computing device of claim 1, wherein the processing resource is to determine whether the unsafe delivery is predicted to occur based on a location of a mobile device.

6. The computing device of claim 1, wherein the processing resource is to determine whether the unsafe delivery is predicted to occur based on an input from an Internet of Things (IoT) device at the location.

7. A non-transitory machine-readable storage medium including instructions that when executed cause a processing resource to:
schedule a shipment of a print material supply to a location via a shipping service;
determine whether a thermal excursion is predicted to occur for the print material supply based on:
a predicted time period for a delivery of the print material supply to the location according to shipping information associated with the shipping service; and
weather information for the location;
determine, in response to the thermal excursion being predicted, whether an unsafe delivery of the print material supply is predicted to occur at the location based on delivery site setup information about the location; and
in response to the unsafe delivery being predicted, cause thermal protection to be provided for the print material supply during shipment to the location.

8. The non-transitory storage medium of claim 7, wherein the instructions to cause the thermal protection to be provided further include instructions to reschedule the predicted time period for the delivery.

9. The non-transitory storage medium of claim 7, wherein the instructions to cause the thermal protection to be provided further include instructions to select a different shipping service for the delivery of the print material supply to the location.

10. The non-transitory storage medium of claim 7, wherein the instructions to cause the thermal protection to be provided further include instructions to cause the shipping service to package the print material supply to remediate the unsafe delivery.

11. A method, comprising:
transmitting, by an imaging device including a first print material supply, a fulfillment signal to a computing device in response to an amount of print material in the first print material supply being less than a threshold amount;
scheduling, by the computing device, a shipment of a second print material supply to a location via a shipping service in response to receiving the fulfillment signal from the imaging device;
determining, by the computing device, whether a thermal excursion is predicted to occur for the second print material supply based on:
a predicted time period for a delivery of the second print material supply to the location according to shipping information associated with the shipping service; and
weather information for the location;
determining, by the computing device in response to the thermal excursion being predicted, whether an unsafe delivery of the second print material supply is predicted to occur at the location based on delivery site setup information about the location; and
causing; by the computing device in response to the unsafe delivery being predicted, thermal protection to be provided for the second print material supply during shipment to the location.

12. The method of claim 11, wherein the method includes transmitting, by the computing device, a notification to a mobile device of a recipient of the second print material supply that the delivery is scheduled to occur within a threshold amount of time relative to the predicted time period for the delivery.

13. The method of claim 12, wherein:
in response to the computing device receiving a confirmation of the delivery from the mobile device; causing the delivery to occur; and
in response to the computing device not receiving a confirmation of the delivery from the mobile device, causing the delivery to be rescheduled.

14. The method of claim 13, wherein the method includes transmitting the notification in response to a temperature at the location exceeding a threshold temperature.

15. The method of claim 11, wherein the method includes:
determining, by the computing device, whether a temperature at the location exceeds a threshold temperature within a range of time after the delivery of the second print material supply to the location; and
in response to the temperature exceeding the threshold temperature within the range of time after the delivery, transmitting a notification to a mobile device of a recipient of the second print material supply.
